(19) United States
(12) Patent Application Publication
(10) Pub. No.: US 2026/0083270 A1
(43) Pub. Date: Mar. 26, 2026

(54) INTEGRATED LID STRUCTURE AND BEVERAGE POT

(71) Applicant: Hangzhou Yingmaode Household Items Co., Ltd., Hangzhou (CN)

(72) Inventors: Xinzuo JIN, Hangzhou (CN); Yun WANG, Wuhu (CN)

(73) Assignee: Hangzhou Yingmaode Household Items Co., Ltd., Hangzhou (CN)

(21) Appl. No.: 18/922,016

(22) Filed: Oct. 21, 2024

(30) Foreign Application Priority Data
Sep. 20, 2024 (CN) 2024113178788

(51) Int. Cl. A47J 31/06; A47J 31/44; B65D 47/08; B65D 51/24

(52) U.S. Cl. CPC A47J 31/0636; A47J 31/446; B65D 47/08; B65D 51/242

(57) ABSTRACT

The present application provides an integrated lid structure and a beverage pot. The integrated lid structure includes a lid and a filter screen module, where the lid is configured to be connected to a container body; the lid is provided with a water outlet and a filter screen space; the water outlet and the filter screen space are adjacently arranged; the filter screen module is arranged relative to the filter screen space; the filter screen module is integrated into the lid, so that a filter function is added in the lid, thereby facilitating integrating a filter effect by the integrated lid structure; the filter screen module includes a filter screen member, and the filter screen member is detachably connected to the lid, so that the filter screen member can be connected to or separated from the lid; and the filter screen member is configured to filter to-be-dissolved matter.

### CROSS-REFERENCE TO RELATED APPLICATIONS

The application claims priority to Chinese patent application No. 2024113178788, filed on Sep. 20, 2024, the entire contents of which are incorporated herein by reference.

### TECHNICAL FIELD

The present invention relates to the technical field of beverage pots, and in particular, to an integrated lid structure and a beverage pot.

### BACKGROUND

With the improvement of living conditions, solid beverages are becoming more and more popular among consumers, especially those solid beverages rich in nutrients such as vitamins, minerals, amino acids, and the like, which can replenish the nutrients needed for human metabolism in time and become a good and indispensable companion in many people's lives. However, after solid beverages such as coffee and the like are mixed with water, in order to obtain a better taste, a pot body is usually placed in a refrigerator for refrigeration, but there are still some problems with existing beverage brewing containers. For example, when mixed liquid of coffee and water is poured out, coffee powder that has not been completely dissolved may follow the mixed liquid into the mouth, affecting the taste of the coffee. In addition, because the coffee and the water cannot be separated, the coffee powder may collide in the pot body when the mixed liquid is poured, causing that the mixed liquid splashes everywhere.

### SUMMARY

A purpose of the present invention is to provide an integrated lid structure and a beverage pot. A lid is configured to be connected to a container body; the lid is provided with a water outlet and filter screen space; the water outlet and the filter screen space are adjacently arranged; the filter screen module is arranged relative to the filter screen space; the filter screen module is integrated into the lid, so that a filter function is added in the lid, thereby facilitating integrating a filter effect by the integrated lid structure; the filter screen module includes a filter screen member, and the filter screen member is detachably connected to the lid, so that the filter screen member can be connected to or separated from the lid; and the filter screen member is configured to filter to-be-dissolved matter, and when the filter screen member is connected to the lid, the filter screen member is arranged relative to the filter screen space, and the filter screen member filters the to-be-dissolved matter in the container body, to avoid filtering the to-be-dissolved matter in an external filter after being poured out, thereby improving a filter effect of the integrated lid structure.

To achieve the above objectives, the present invention provides a technical solution as follows:

An integrated lid structure, applied to a beverage pot, where the integrated lid structure includes:
a lid, configured to be connected to a container body, where the lid is provided with a water outlet and a filter screen space; and the water outlet and the filter screen space are adjacently arranged; and
a filter screen module, arranged relative to the filter screen space, where the filter screen module is integrated into the lid; the filter screen module includes a filter screen member, and the filter screen member is detachably connected to the lid; and the filter screen member is configured to filter to-be-dissolved matter.

Optionally, the lid is provided with a first connecting portion; and the first connecting portion is located in the filter screen space; and
the filter screen member is provided with a second connecting portion, and the second connecting portion is detachably connected to the first connecting portion.

Optionally, when the first connecting portion is a first snap portion, the second connecting portion is a second snap portion, and the second snap portion is connected to the first snap portion in a rotatory clamping manner; or
when the first connecting portion is a third snap portion, the second connecting portion is a fourth snap portion, and the fourth snap portion is connected to the third snap portion in an up-down clamping manner.

Optionally, when the first connecting portion is a first threaded portion, the second connecting portion is a second threaded portion, and the second threaded portion is in threaded connection with the first threaded portion.

Optionally, the filter screen member is provided with a filter hole and an accommodation space, and the accommodation space is configured to accommodate the to-be-dissolved matter; and the filter hole is communicated with the accommodation space and is configured to allow liquid filtered by the to-be-dissolved matter to pass through.

Optionally, the filter screen module further includes a bottom lid, the bottom lid is located on a bottom portion of the filter screen member, and the bottom lid is detachably connected to the filter screen member; and the bottom lid is configured to seal or open a bottom portion of the accommodation space.

Optionally, the filter screen module further includes a top lid, the top lid is located on a top portion of the filter screen member, and the top lid is connected to the filter screen member; and the top lid is configured to seal a top portion of the accommodation space.

Optionally, the integrated lid structure further includes a flap module, and the flap module includes a flap and a sealing member; the flap is mounted on the lid in a turnover manner and closes or opens the water outlet; and the sealing member is connected to the flap and is connected to the water outlet in a sealing manner as the flap closes the water outlet; and
the sealing member is disposed in the flap and is connected to an inner side wall, facing the water outlet, of the flap in a positioning manner.

Optionally, the lid is provided with a handle portion, and the handle portion is located on an outer side of the container body; and the handle portion is configured to allow a hand portion of a user to grip.

A beverage pot, including an integrated lid structure and a container body, where the container body is detachably connected to a lid of the integrated lid structure.

Compared with the prior art, beneficial effects of the present invention are as follows:

The present invention provides an integrated lid structure and a beverage pot. A lid is configured to be connected to a container body; the lid is provided with a water outlet and a filter screen space; the water outlet and the filter screen space are adjacently arranged; a filter screen module is arranged relative to the filter screen space; the filter screen module is integrated into the lid, so that a filter function is added in the lid, thereby facilitating integrating a filter effect by the integrated lid structure; the filter screen module includes a filter screen member, and the filter screen member is detachably connected to the lid, so that the filter screen member can be connected to or separated from the lid; and the filter screen member is configured to filter to-be-dissolved matter, and when the filter screen member is connected to the lid, the filter screen member is arranged relative to the filter screen space, and the filter screen member filters the to-be-dissolved matter in a container body, to avoid filtering the to-be-dissolved matter in an external filter after being poured out, thereby improving a filter effect of the integrated lid structure.

### BRIEF DESCRIPTION OF THE DRAWINGS

To describe the technical solutions in the embodiments of the present application more clearly, a brief introduction will be given below to the accompanying drawings required in the description of the embodiments. Apparently, the accompanying drawings in the following description only show some embodiments of the present application, and a person skilled in the art may further derive other accompanying drawings from these accompanying drawings without creative labor.

To understand the present application and beneficial effects thereof more completely, the following description will be made with reference to the accompanying drawings. The same parts are denoted by the same reference numerals in the following description.

FIG. 1 is a schematic diagram of an integrated lid structure according to an embodiment of the present application;

FIG. 2 is a sectional view of an integrated lid structure according to an embodiment of the present application;

FIG. 3 is a schematic diagram of a lid of an integrated lid structure according to an embodiment of the present application;

FIG. 4 is a sectional view of a lid of an integrated lid structure according to an embodiment of the present application;

FIG. 5 is a schematic diagram of a filter screen module of an integrated lid structure according to an embodiment of the present application;

FIG. 6 is a sectional view of a filter screen module of an integrated lid structure according to an embodiment of the present application;

FIG. 7 is a schematic diagram of a flap module of an integrated lid structure according to an embodiment of the present application;

FIG. 8 is a sectional view of a flap module of an integrated lid structure according to an embodiment of the present application;

FIG. 9 is a schematic diagram of a sealing member of an integrated lid structure according to an embodiment of the present application.

### REFERENCE NUMERALS

100: integrated lid structure;
10: lid; 10a: water outlet; 10b: filter screen space; 10c: gas outlet; 11: first connecting portion; 12: second latch portion; 13: handle portion;
20: filter screen module; 21: filter screen member; 21a: filter hole; 21b: accommodation space; 211: second connecting portion; 22: bottom lid; 23: top lid;
30: flap module; 31: flap; 311: positioning portion; 312: limiting portion; 32: sealing member; 32a: positioning groove; 321: sealing portion; 322: elastic support arm; 33: latch; 33a: groove; 331: first latch portion.

### DETAILED DESCRIPTION OF THE EMBODIMENTS

The following describes the technical solutions in the embodiments of the present application clearly and completely with reference to the accompanying drawings in the embodiments of the present application. Obviously, the described embodiments are merely some, but not all, of the embodiments of the present application. All other embodiments obtained by those skilled in the art based on the embodiments of the present application without creative efforts shall fall within the protection scope of the present application.

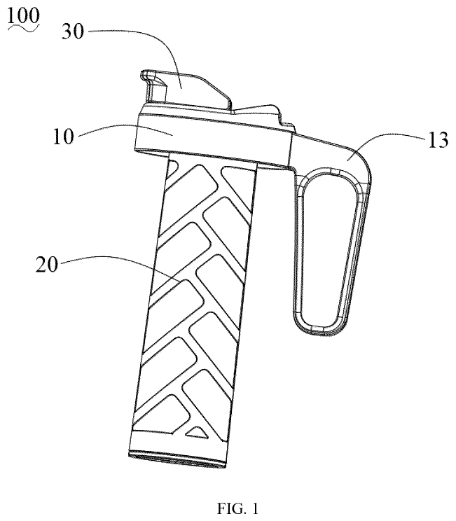

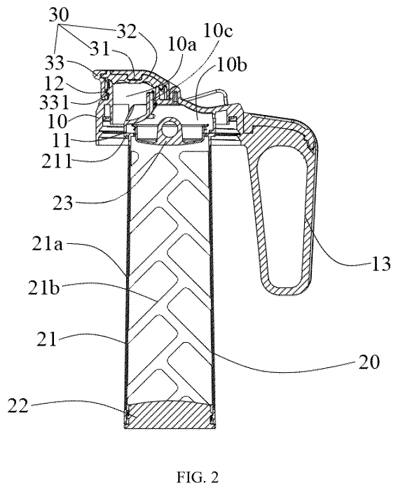

Referring to FIGS. 1 and 2, an embodiment of the present application provides an integrated lid structure 100, the integrated lid structure 100 is used as a part of a beverage pot, and the integrated lid structure 100 is configured to filter to-be-dissolved matter.

Referring to FIGS. 1 and 2, in the embodiment of the present application, the integrated lid structure 100 includes a lid 10 and a filter screen module 20. The filter screen module 20 is disposed on a lower side of the lid 10, and the filter screen module 20 is integrated into the lid 10, so that a filter function is added in the lid 10, thereby facilitating integrating a filter effect by the integrated lid structure 100. The filter screen module 20 includes a filter screen member 21, and the filter screen member 21 is detachably connected to the lid 10, so that the filter screen member 21 can be connected to or separated from the lid 10. The filter screen member 21 is configured to filter the to-be-dissolved matter, and when the filter screen member 21 is connected to the lid 10, the filter screen member 21 is arranged relative to the filter screen space 10b, and the filter screen member 21 filters the to-be-dissolved matter in a container body, to avoid filtering the to-be-dissolved matter in an external filter after being poured out, thereby improving a filter effect of the integrated lid structure 100.

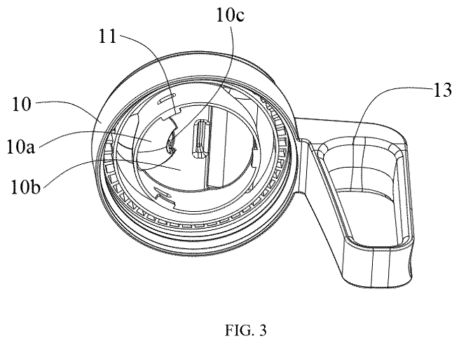

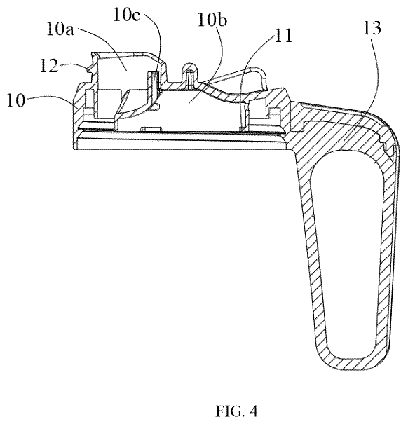

Referring to FIGS. 1 to 4, in the embodiment of the present application, the lid 10 is used as a support component of the integrated lid structure 100, the lid 10 is configured to support the filter screen module 20, and the lid 10 is configured to be connected to the container body, so that the lid 10 is fixed on the container body; the lid 10 is provided with a water outlet 10a and the filter screen space 10b; the water outlet 10a and the filter screen space 10b are adjacently arranged, and the water outlet 10a is configured to allow water to pass through, so that liquid flows toward an external environment; and the filter screen space 10b is configured to be docked with the filter screen module 20.

Referring to FIGS. 1 and 2 and FIGS. 5 and 6, in the embodiment of the present application, the filter screen module 20 is arranged relative to the filter screen space 10b; the filter screen module 20 is integrated into the lid 10, so that the filter function is added in the lid 10, thereby facilitating integrating the filter effect by the integrated lid structure 100. The filter screen module 20 includes the filter screen member 21, and the filter screen member 21 is detachably connected to the lid 10, so that the filter screen member 21 can be connected to or separated from the lid 10. The filter screen member 21 is configured to filter the to-be-dissolved matter, and when the filter screen member 21 is connected to the lid 10, the filter screen member 21 is arranged relative to the filter screen space 10b, and the filter screen member 21 filters the to-be-dissolved matter in the container body, to avoid filtering the to-be-dissolved matter in an external filter after being poured out, thereby improving the filter effect of the integrated lid structure 100. When the filter screen member 21 is separated from the lid 10, a top portion of the filter screen member 21 comes out to be in an open state, thereby facilitating pouring the to-be-dissolved matter into the filter screen member 21, to implement that the filter screen member 21 stores the to-be-dissolved matter. Optionally, the to-be-dissolved matter is coffee powder.

Referring to FIGS. 1 and 2 and FIGS. 5 and 6, the lid 10 is provided with a first connecting portion 11; the first connecting portion 11 is located in the filter screen space 10b; and the filter screen member 21 is provided with a second connecting portion 211. The second connecting portion 211 is detachably connected to the first connecting portion 11, so that the second connecting portion 211 can be connected to or separated from the first connecting portion 11. Therefore, the filter screen member 21 is detachably connected to the lid 10 through the second connecting portion 211 and the first connecting portion 11, to implement that the filter screen member 21 can be connected to or separated from the lid 10.

In a first embodiment, when the first connecting portion 11 is a first snap portion, the second connecting portion 211 is a second snap portion, and the second snap portion is connected to the first snap portion in a rotatory clamping manner. At this time, when the second snap portion is docked with the first snap portion during rotation, the second snap portion is clamped to the first snap portion, and when the second snap portion is staggered from the first snap portion during rotation, the second snap portion is separated from the first snap portion, so that the second snap portion rotates under external force to be clamped to or separated from the first snap portion, to implement that the filter screen member 21 is connected to or separated from the lid 10 during rotation.

In a second embodiment, when the first connecting portion 11 is a third snap portion, the second connecting portion 211 is a fourth snap portion, and the fourth snap portion is connected to the third snap portion in an up-down clamping manner. At this time, when the fourth snap portion is aligned with the third snap portion from up to down, the fourth snap portion is clamped to the third snap portion, and when the fourth snap portion is staggered from the third snap portion from up to down, the fourth snap portion is separated from the third snap portion, so that the fourth snap portion moves up and down under external force to be clamped to or separated from the third snap portion, to implement that the filter screen member 21 is connected to or separated from the lid 10 during up and down movement.

In a third embodiment, when the first connecting portion 11 is a first threaded portion, the second connecting portion 211 is a second threaded portion, and the second threaded portion is in threaded connection with the first threaded portion, so that the second threaded portion is detachably connected to the first threaded portion in a threaded connection manner. Therefore, the filter screen member 21 is connected to or separated from the lid 10 through the second threaded portion and the first threaded portion. Optionally, the first threaded portion is provided with an inner thread, the second threaded portion is provided with an outer thread, and the outer thread is engaged with the inner thread.

Referring to FIGS. 1 and 2 and FIGS. 5 and 6, the filter screen member 21 is provided with a filter hole 21a and an accommodation space 21b. The accommodation space 21b is used as an internal space of the filter screen member 21, and the accommodation space 21b is configured to accommodate the to-be-dissolved matter, so that the accommodation space 21b stores the to-be-dissolved matter. The filter hole 21a is communicated with the accommodation space 21b and is configured to allow liquid filtered by the to-be-dissolved matter to pass through. At this time, when the filter screen member 21 is located on an inner side of the container body, and an inner cavity of the container body is communicated with the filter hole 21a and the accommodation space 21b in sequence, so that the liquid filtered by the to-be-dissolved matter in the accommodation space 21b flows to the inner cavity of the container body through the filter hole 21a. Therefore, the inner cavity of the container body stores filtered liquid.

The lid 10 is provided with a gas outlet 10c, the gas outlet 10c is located on one side of the water outlet 10a, and the gas outlet 10c is communicated with the inner cavity of the filter screen member 21, so that gas in the filter screen member 21 is discharged into the external environment through the gas outlet 10c, to discharge the gas.

Referring to FIGS. 1 and 2 and FIGS. 5 and 6, the filter screen module 20 further includes a bottom lid 22, the bottom lid 22 is located on a bottom portion of the filter screen member 21, and the bottom lid 22 is detachably connected to the filter screen member 21, so that the bottom lid 22 can be connected to or separated from the filter screen member 21. The bottom lid 22 is configured to seal or open a bottom portion of the accommodation space 21b. When the bottom lid 22 seals the bottom portion of the accommodation space 21b, the bottom lid 22 is combined with the accommodation space 21b to accommodate the to-be-dissolved matter, so that the to-be-dissolved matter is stored, thereby avoiding leakage of the to-be-dissolved matter through the bottom portion of the accommodation space 21b. When the bottom lid 22 opens the bottom portion of the accommodation space 21b, the bottom portion of the accommodation space 21b is exposed, so that a user cleans the accommodation space 21b, thereby improving convenience of cleaning the filter screen member 21.

Referring to FIGS. 1 and 2 and FIGS. 5 and 6, the filter screen module 20 further includes a top lid 23, the top lid 23 is located on a top portion of the filter screen member 21, and the top lid 23 is detachably connected to the filter screen member 21, so that the top lid 23 can be connected to or separated from the filter screen member 21. The top lid 23 is configured to seal or open a top portion of the accommodation space 21b. When the top lid 23 seals the top portion of the accommodation space 21b, the to-be-dissolved matter in the accommodation space 21b is prevented from separating from the accommodation space 21b through the top portion of the accommodation space 21b, thereby avoiding that the to-be-dissolved matter leaks through the top portion of the accommodation space 21b. When the top lid 23 opens the top portion of the accommodation space 21b, the to-be-dissolved matter enters the accommodation space 21b through the top portion of the accommodation space 21b, so that the accommodation space 21b stores the to-be-dissolved matter.

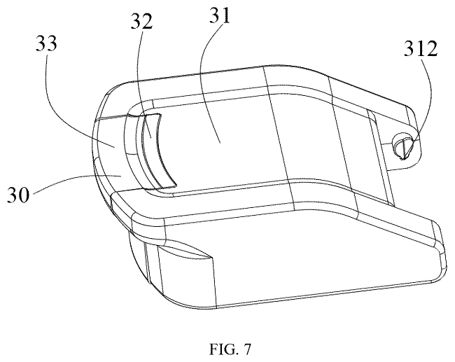

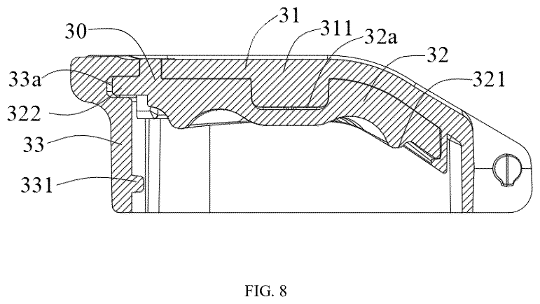

Referring to FIGS. 1 and 2 and FIGS. 7 and 8, the integrated lid structure 100 further includes a flap module 30, and the flap module 30 includes a flap 31 and a sealing member 32. The flap 31 is mounted on the lid 10 in a turnover manner, so that the flap 31 swings along an axis along a connection position between the flap 31 and the lid 10, thereby facilitating adjusting a position, relative to the lid 10, of the flap 31, and the flap 31 closes or open the water outlet 10a. The sealing member 32 is connected to the flap 31 and is connected to the water outlet 10a in a sealing manner as the flap 31 closes the water outlet 10a, so as to adjust a position, relative to the water outlet 10a, of the sealing member 32 and seal the water outlet 10a through the sealing member 32 based on the flap 31, to implement a function of sealing the water outlet 10a, thereby preventing the water outlet 10a from leaking and improving a sealing effect of the flap module 30.

Referring to FIGS. 1 and 2 and FIGS. 7 and 8, the sealing member 32 is disposed in the flap 31, so that the sealing member 32 is fixed on an inner side of the flap 31. The sealing member 32 is connected to an inner side wall, facing the water outlet 10a, of the flap 31 in a positioning manner, thereby ensuring accuracy of a position, relative to the flap 31, of the sealing member 32, so that the sealing member 32 is docked with the water outlet 10a. When the flap 31 closes the lid 10 from up to down, the sealing member 32 disposed in the flap 31 seals the water outlet 10a from up and down, to implement a function of sealing the water outlet 10a, thereby preventing the water outlet 10a from leaking and improving a sealing effect of the flap module 30.

Referring to FIGS. 1 and 2 and FIGS. 7 and 8, the inner side wall, facing the water outlet 10a, of the flap 31 is provided with a positioning portion 311 in a protrusion manner. The sealing member 32 is provided with a positioning groove 32a, the positioning groove 32a is recessed from the sealing member 32 from up to down, a groove opening of the positioning groove 32a faces upward, an outer contour of the positioning portion 311 is matched with an inner contour of the positioning groove 32a, and the positioning groove 32a is connected to the positioning portion 311 is a positioning manner, so that an inner side wall of the positioning groove 32a abuts against the outer contour of the positioning portion 311, thereby ensuring accuracy of positions of the positioning groove 32a and the positioning portion 311. Therefore, the sealing member 32 is connected to the flap 31 in a positioning manner through the positioning groove 32a and the positioning portion 311. Optionally, the outer contour of the positioning portion 311 is in interference with the inner contour of the positioning groove 32a, thereby ensuring connection stability between the positioning portion 311 and the positioning groove 32a.

Referring to FIGS. 1 and 2 and FIGS. 7 and 8, the sealing member 32 is a silicon rubber member and opens or seals the water outlet 10a as the flap 31 turns over relative to the lid 10. When the sealing member 32 seals the water outlet 10a, the sealing member 32 is connected to the water outlet 10a in a sealing manner. At this time, the silicon rubber member has an elastic effect, so that an inner contour of the water outlet 10a squeezes an outer contour of the silicon rubber member, thereby ensuring a sealing effect of a connection position between the water outlet 10a and the sealing member 32, to implement a function of sealing the water outlet 10a, thereby preventing the water outlet 10a from leaking and improving a sealing effect of the flap module 30.

Referring to FIGS. 1 and 2 and FIGS. 7 and 8, a side wall of the sealing member 32 is provided with a sealing portion 321 in a protrusion manner, the sealing portion 321 is located on one side, away from the positioning groove 32a, of the sealing member 32, and an edge of the sealing portion 321 is elastically squeezed by an end portion, relative to the water outlet 10a, in the lid 10, so that the edge of the sealing portion 321 is tightly attached to an end portion of the water outlet 10a. A middle portion of the sealing portion 321 can seal the water outlet 10a, so that the sealing member 32 is connected to the water outlet 10a in a sealing manner through the sealing portion 321, to implement a function of sealing the water outlet 10a, thereby preventing the water outlet 10a from leaking and improving a sealing effect of the flap module 30.

Referring to FIGS. 1 and 2 and FIGS. 7 and 8, the edge of the sealing portion 321 protrudes and extends toward the end portion, relative to the water outlet 10a, in the lid 10, so that the sealing portion 321 is clamped to the water outlet 10a, thereby ensuring connection stability between the sealing portion 321 and the water outlet 10a and further improving a sealing effect between the sealing portion 321 and the water outlet 10a.

Referring to FIGS. 1 and 2 and FIGS. 7 and 8, the flap module 30 further includes a latch 33, the latch 33 is disposed on a front side of the flap 31, and the latch 33 is connected to the flap 31 in a swing able manner, so that the latch 33 swings along an axis of a connection position between the latch 33 and the flap 31, thereby facilitating adjusting a position, relative to the flap 31, of the latch 33. The latch 33 locks or opens the lid 10, so that the flap 31 locks or opens the lid 10 through the latch 33. When the latch 33 locks the lid 10, the flap 31 closes the lid 10, so that the flap 31 cannot swing relative to the lid 10, thereby facilitating limiting the position, relative to the lid 10, of the flap 31. At the same time, the sealing member 32 seals the water outlet 10a, to implement the function of sealing the water outlet 10a, thereby preventing the water outlet 10a from leaking and improving the sealing effect of the flap module 30. When the latch 33 opens the lid 10, the flap 31 can swing relative to the lid 10, so that the flap 31 drives the sealing member 32 to be separated from the water outlet 10a, thereby further facilitating flowing toward the external environment by the water through the water outlet 10a and using the water.

Referring to FIGS. 1 and 2 and FIGS. 7 and 8, the lid 10 is provided with a second latch portion 12; the latch 33 is hinged to the flap 31, so that the latch 33 swings relative to the flap 31 in hinging manner; and the latch 33 is provided with a first latch portion 331, and the first latch portion 331 is connected to the second latch portion 12 in a locking manner, so that the first latch portion 331 and the second latch portion 12 are limited to each other, and therefore, the latch 33 locks the lid 10 through locking between the first latch portion 331 and the second latch portion 12, thereby facilitating limiting the position, relative to the lid 10, of the flap 31. When the first latch portion 331 is separated from the second latch portion 12 under external force, the latch 33 opens the lid 10, so that the latch 33 locks or opens the lid 10 through the first latch portion 331 and the second latch portion 12.

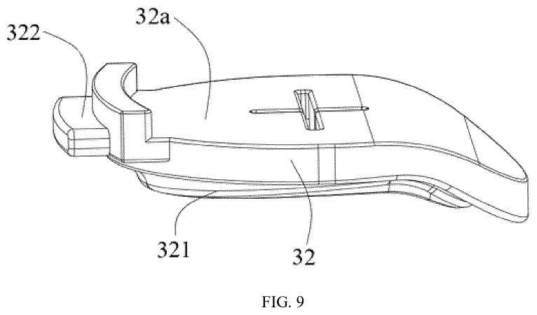

Referring to FIG. 9, the sealing member 32 is provided with an elastic support arm 322, and the elastic support arm 322 is inserted into the latch 33 and applies elastic force to the latch 33, so that the latch 33 elastically locks the lid 10 under the elastic force of the elastic support arm 322. Therefore, the latch 33 improves locking strength between the latch 33 and the lid 10 through the elastic support arm 322, thereby ensuring locking stability between the latch 33 and the lid 10. The elastic support arm 222 and the sealing portion 321 are of an integrated structure and are made of a silicon rubber material.

The latch 33 is provided with a groove 33a, and a groove opening of the groove 33a faces the elastic support arm 322, so that the elastic support arm 322 is inserted into the groove 33a along a horizontal direction, and the elastic support arm 322 is inserted into the latch 33 through the groove 33a. Therefore, the elastic support arm 322 abuts against an inner side wall of the groove 33a under the elastic force, thereby facilitating applying the elastic force to the latch 33 by the elastic support arm 322. Therefore, a latch elastic member in a conventional lid body needs to use metals such as a spring to improve elastic force and is prone to rusting after being used for a long time to affect sanitation, it is relatively complex to mount the lid body, and other problems are avoided. Meanwhile, the elastic support arm and the sealing portion are of an integrated structure and jointly form a sealing member made of a silicon rubber material, so that an elastic component of the spring is omitted, resulting in convenient mounting and better sealing property.

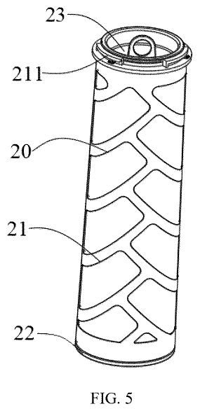

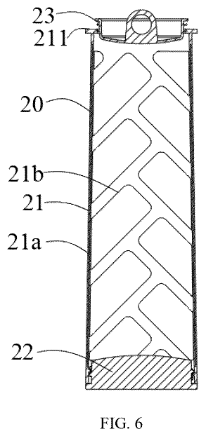

Referring to FIGS. 5 and 6, the lid 10 is provided with a handle portion 13, and the handle portion 13 is located on an outer side of the container body. The handle portion 13 is configured to allow a hand portion of a user to grip, so that a gripping function is added on the lid 10, thereby facilitating integrating a gripping effect by the integrated lid structure 100. When the lid 10 is connected to the container body, the user grips the handle portion 13 to drive the container body to tilt, thereby facilitating pouring out liquid in the container body and improving gripping convenience of the integrated lid structure 100.

The flap 31 swings relative to the lid 10 in a rotating shaft manner, a peripheral side of each of hinging shafts on two sides of the flap 31 is provided with a protruding limiting portion 312, and a side wall of a rotating cavity for accommodating the rotating shaft on the lid is provided with a groove that is configured to be clamped to a corresponding limiting portion 312. When the lid 10 is in an open state, the limiting portion 312 enters a corresponding groove, so that the flap 31 limits swinging that is relative to the lid 10 through the limiting portion 312, thereby preventing the flap 31 from swinging in the open state during water drinking.

In a fourth embodiment, a beverage pot includes an integrated lid structure 100 and a container body. The container body is detachably connected to a lid 10 of the integrated lid structure 100, so that the container body can be connected to or separated from the lid 10 of the integrated lid structure 100, thereby facilitating integrating a filter function and a gripping function by the beverage pot.

At this time, a filter screen module 20 includes a filter screen member 21, and the filter screen member 21 is detachably connected to the lid 10, so that the filter screen member 21 can be connected to or separated from the lid 10. The filter screen member 21 is configured to filter to-be-dissolved matter, and when the filter screen member 21 is connected to the lid 10, the filter screen member 21 is arranged relative to a filter screen space 10b, and the filter screen member 21 filters the to-be-dissolved matter in the container body, to avoid filtering the to-be-dissolved matter in an external filter after being poured out, thereby improving a filter effect of the beverage pot. When the filter screen member 21 is separated from the lid 10, a top portion of the filter screen member 21 comes out to be in an open state, thereby facilitating pouring the to-be-dissolved matter into the filter screen member 21, to implement that the filter screen member 21 stores the to-be-dissolved matter.

The lid 10 is provided with a first connecting portion 11; the first connecting portion 11 is located in the filter screen space 10b; and the filter screen member 21 is provided with a second connecting portion 211. The second connecting portion 211 is detachably connected to the first connecting portion 11, so that the second connecting portion 211 can be connected to or separated from the first connecting portion 11. Therefore, the filter screen member 21 is detachably connected to the lid 10 through the second connecting portion 211 and the first connecting portion 11, to implement that the filter screen member 21 can be connected to or separated from the lid 10.

In addition, the filter screen member 21 is provided with a filter hole 21a and an accommodation space 21b. The accommodation space 21b is used as an internal space of the filter screen member 21, and the accommodation space 21b is configured to accommodate the to-be-dissolved matter, so that the accommodation space 21b stores the to-be-dissolved matter. The filter hole 21a is communicated with the accommodation space 21b and is configured to allow liquid filtered by the to-be-dissolved matter to pass through. At this time, when the filter screen member 21 is located on an inner side of the container body, and an inner cavity of the container body is communicated with the filter hole 21a and the accommodation space 21b in sequence, so that the liquid filtered by the to-be-dissolved matter in the accommodation space 21b flows to the inner cavity of the container body through the filter hole 21a. Therefore, the inner cavity of the container body stores filtered liquid.

The filter screen module 20 further includes a bottom lid 22, the bottom lid 22 is located on a bottom portion of the filter screen member 21, and the bottom lid 22 is detachably connected to the filter screen member 21, so that the bottom lid 22 can be connected to or separated from the filter screen member 21. The bottom lid 22 is configured to seal or open a bottom portion of the accommodation space 21b. When the bottom lid 22 seals the bottom portion of the accommodation space 21b, the bottom lid 22 is combined with the accommodation space 21b to accommodate the to-be-dissolved matter, so that the to-be-dissolved matter is stored, thereby avoiding leakage of the to-be-dissolved matter through the bottom portion of the accommodation space 21b. When the bottom lid 22 opens the bottom portion of the accommodation space 21b, the bottom portion of the accommodation space 21b is exposed, so that a user cleans the accommodation space 21b, thereby improving convenience of cleaning the filter screen member 21.

The filter screen module 20 further includes a top lid 23, the top lid 23 is located on a top portion of the filter screen member 21, and the top lid 23 is detachably connected to the filter screen member 21, so that the top lid 23 can be connected to or separated from the filter screen member 21. The top lid 23 is configured to seal or open a top portion of the accommodation space 21b. When the top lid 23 seals the top portion of the accommodation space 21b, the to-be-dissolved matter in the accommodation space 21b is prevented from separating from the accommodation space 21b through the top portion of the accommodation space 21b, thereby avoiding that the to-be-dissolved matter leaks through the top portion of the accommodation space 21b. When the top lid 23 opens the top portion of the accommodation space 21b, the to-be-dissolved matter enters the accommodation space 21b through the top portion of the accommodation space 21b, so that the accommodation space 21b stores the to-be-dissolved matter.

Compared with the prior art, beneficial effects of the present invention are as follows:

The present invention provides an integrated lid structure 100 and a beverage pot. A lid 10 is configured to be connected to a container body; the lid 10 is provided with a water outlet 10a and a filter screen space 10b; the water outlet 10a and the filter screen space 10b are adjacently arranged; a filter screen module 20 is arranged relative to the filter screen space 10b; the filter screen module 20 is integrated into the lid 10, so that a filter function is added in the lid 10, thereby facilitating integrating a filter effect by the integrated lid structure 100; the filter screen module 20 includes a filter screen member 21, and the filter screen member 21 is detachably connected to the lid 10, so that the filter screen member 21 can be connected to or separated from the lid 10; and the filter screen member 21 is configured to filter to-be-dissolved matter, and when the filter screen member 21 is connected to the lid 10, the filter screen member 21 is arranged relative to the filter screen space 10b, and the filter screen member 21 filters the to-be-dissolved matter in a container body, to avoid filtering the to-be-dissolved matter in an external filter after being poured out, thereby improving a filter effect of the integrated lid structure 100.

In the above embodiments, the descriptions of each embodiment have respective focuses. For a part that is not described in detail in an embodiment, refer to related descriptions in other embodiments.

In the description of the present application, the terms “first” and “second” are merely intended for a purpose of description, and should not be construed as indicating or implying their relative importance or implying the quantity of technical features indicated. Therefore, a feature limited by “first” or “second” may explicitly or implicitly include one or more features.

The principle and implementations of the present application are elaborated by applying specific examples herein. The descriptions of the above embodiments are only used to help understand the method and its core idea of the present application. Meanwhile, according to the idea of the present application, there will be changes in the specific implementations and the application scope for a person skilled in the art. In summary, the content of the description should not be understood as a limitation to the present application.

What is claimed is:

1. An integrated lid structure, applied to a beverage pot, wherein the integrated lid structure comprises:
a lid, configured to be connected to a container body, wherein the lid is provided with a water outlet and a filter screen space; and the water outlet and the filter screen space are adjacently arranged; and
a filter screen module, arranged relative to the filter screen space, wherein the filter screen module is integrated into the lid; the filter screen module comprises a filter screen member, and the filter screen member is detachably connected to the lid; and the filter screen member is configured to filter to-be-dissolved matter.

2. The integrated lid structure according to claim 1, wherein the filter screen member is provided with a filter hole and an accommodation space, and the accommodation space is configured to accommodate the to-be-dissolved matter; and the filter hole is communicated with the accommodation space and is configured to allow liquid filtered by the to-be-dissolved matter to pass through.

3. The integrated lid structure according to claim 2, wherein the filter screen module further comprises a bottom lid, the bottom lid is located on a bottom portion of the filter screen member, and the bottom lid is detachably connected to the filter screen member; and the bottom lid is configured to seal or open a bottom portion of the accommodation space.

4. The integrated lid structure according to claim 2, wherein the filter screen module further comprises a top lid, the top lid is located on a top portion of the filter screen member, and the top lid is connected to the filter screen member; and the top lid is configured to seal a top portion of the accommodation space.

5. The integrated lid structure according to claim 1, wherein the integrated lid structure further comprises a flap module, and the flap module comprises a flap and a sealing member; the flap is mounted on the lid in a turnover manner and closes or opens the water outlet; and the sealing member is connected to the flap and is connected to the water outlet in a sealing manner as the flap closes the water outlet; and
the sealing member is disposed in the flap and is connected to an inner side wall, facing the water outlet, of the flap in a positioning manner.

6. The integrated lid structure according to claim 1, wherein the lid is provided with a first connecting portion; and the first connecting portion is located in the filter screen space; and
the filter screen member is provided with a second connecting portion, and the second connecting portion is detachably connected to the first connecting portion.

7. The integrated lid structure according to claim 6, wherein when the first connecting portion is a first snap portion, the second connecting portion is a second snap portion, and the second snap portion is connected to the first snap portion in a rotatory clamping manner; or
when the first connecting portion is a third snap portion, the second connecting portion is a fourth snap portion, and the fourth snap portion is connected to the third snap portion in an up-down clamping manner.

8. The integrated lid structure according to claim 6, wherein when the first connecting portion is a first threaded portion, the second connecting portion is a second threaded portion, and the second threaded portion is in threaded connection with the first threaded portion.

9. The integrated lid structure according to claim 1, wherein the lid is provided with a handle portion, and the handle portion is located on an outer side of the container body; and the handle portion is configured to allow a hand portion of a user to grip.

10. A beverage pot, comprising an integrated lid structure and a container body according to claim 1, wherein the container body is detachably connected to a lid of the integrated lid structure.
